(19) United States
(12) Patent Application Publication
(10) Pub. No.: US 2002/0075131 A1
(43) Pub. Date: Jun. 20, 2002

(54) Cermet thin film resistors

(76) Inventors: Karen L. Coates, Sumner, WA (US); Minas H. Tanielian, Bellevue, WA (US)

Correspondence Address: THE BOEING COMPANY, P.O. BOX 3707 M/C 13-08, SEATTLE, WA, 98124-2207, US

(21) Appl. No.: 09/886,511

(22) Filed: Jun. 21, 2001

Related U.S. Application Data
(62) Division of application No. 09/573,281, filed on May 18, 2000.

(51) Int. Cl. H01C 1/012

(52) U.S. Cl. 338/308

(57) ABSTRACT

A material and method of manufacture of resistors having the following characteristics, as deposited (no annealing required): (a) easily dry etchable; (b) high, low thermal coefficient of resistance (near zero) and (c) high reliability in both long term temperature stability (>1000 hours@+125° C.).

This invention was made with Government support under DARPA agreement F33615-96-2-1838, “Low Cost Mixed Signal Modules Using Embedded Mass formed Passives.” The Government has certain rights to this invention.

### BACKGROUND OF THE INVENTION

1. Field of the Invention

This invention relates to thin film resistor technology and more particularly to W/SiOₓ films and the method of deposition thereof.

2. Description of the Prior Art

Cermet films such as Cr—SiO (see, K. L. Chopra and I. Kaur, “Thin Film Device applications,” Plenum Press, New York, 1983, p. 136) require annealing for stabilization or for lowering the TCR (thermal coefficient of resistance).

Also, NiCr (see, A. Sachaf and I. E. Klein, “Reliability and Robustness of Thin Film Composite Resistor Networks,” Quality and Reliability Engineering International, vol. 8, John Wiley & Sons, Ltd., 1992, pp. 531-536; J. Zelenka et al., “Thin Resistive Film with Temperature Coefficient of Resistance Close to Zero,” Thin solid Films, 200, 1991, pp. 239-246; and C- S. Lee et al., “Structure and Electrical Properties of Stable Tantalum Nitride Thin Film Resistors,” ISHM '93 Proceedings, 1993, pp. 708-713) and Ta_{z}N (see, W. D. Westwood et al., “Tantalum Thin Films,” Academic Press, New York, 1975, pp. xii; C- S. Lee et al., “Structure and Electrical Properties of Stable Tantalum Nitride Thin Film Resistors,” ISHM '93 Proceedings, 1993, pp. 708-713; and C. L. Au et al., “Stability of Tantalum Nitride Thin Film resistors,” Journal of Materials Research, Vol. 5, No. 6, June 1990, pp. 1224-1232), which are currently “the most popular and useful film materials in the manufacturing of thin film resistors (see, A. Elshabini-Riad and F. D. Barlow II, “thin Film Technology Handbook,” McGraw Hill New York, 1998, pp. 5-8) require annealing for stabilization or for lowering the TCR.

### BRIEF SUMMARY OF THE INVENTION

A high value (˜0.2-1.5×10⁻² Ω-cm, which translates to ˜200-1500 Ω/square for a 1000 Å film) thin film resistor material and method for the fabrication of integrated passive components in electronic applications. The present resistor film can be used with both conventional printed wiring boards or with more advanced multichip modules (MCM).

### BRIEF DESCRIPTION OF THE DRAWINGS

FIG. 1 is a graph illustrative of W/SiOₓ thermal shock testing for a 0.25×10⁻² Ω-cm film;

FIG. 2 shows a current sense module MCM layout; and

FIG. 3 is illustrative of a current sense module comparing size of hybrid to an MCM layout.

### DETAILED DESCRIPTION OF THE INVENTION

Improvements in the properties of thin film resistors are needed in order to increase their use as replacements for traditional surface mount components. In order to fully capitalize on the benefits of embedded passives, two ranges of resistance values are needed: ˜0.01-0.05×10⁻² Ω-cm and 0.2-1.5×10⁻² Ω-cm (these ranges are also valid for industry as a whole (R. Frye, “Passive Components in Electronic Applications: Requirements and Prospects for Integration,” The International Journal of Microcircuits and Electronic Packaging, Vol. 19, No. 4, 1996, pp. 483-490). In addition to the resistivity requirement, it was necessary that the resistor fabrication technology be based on thin film processing for compatibility with modules whose interconnections are formed by the thin film deposition of metals on deposited dielectric, which may be polymers or inorganic films (MCM-D) fabrication process (J. Cech et al., Polymer Eng. and Sci., Vol. 32, 1992, p. 1646). To address the needs in the higher resistance range, sputtered W/SiOₓ films were developed as hereinafter described. By adjusting the deposition conditions, the resistivity can be varied from 0.2 to 1.5×10⁻² Ω-cm, while maintaining acceptable TCR values. No annealing is required for stabilization or for lowering the TCR of the films, unlike other cermet films, such as Cr—SiO and unlike NiCr and Ta₂N. In addition, unlike NiCr and CrSiO, the W/SiOₓ or Ta/SiOx film can be easily dry etched, which results in tighter line width tolerances and, therefore, more accurate control of resistor values. Furthermore, the W/SiOₓ film has a higher resistivity than NiCr and Ta₂N. While it is possible to build larger value resistors with Ta₂N and NiCr by increasing the length of the resistor, decreasing the film thickness and/or changing the film composition, these alterations can result in adverse effects. Increasing the length of the resistor is limited by a corresponding decrease in performance (inductance, patterning errors, etc.) and decreasing the film thickness leads to lower power handling capabilities. Finally, changing the composition of the traditionally used films results in a corresponding increase in TCR values, to the point where the films are no longer desirable.

The resistor films hereinafter described fall into a class of materials called cermets (mixtures of metal and insulator materials). There are three possible microstructural regimes for these materials. The first is the case where the metal fraction is larger than 0.5 and thus a continuous metallic network exists. The second possible regime is where small isolated metal grains are embedded in a dielectric matrix and the third regime is the transition region where a labyrinthine structure extends throughout the film. The first regime is characterized by low resistivities and positive TCR, the second by large resistivities and negative TCR, while the transition region harbors the desired, nearly zero TCR values while having a reasonably high “effective” resistivity. While the resistivity tends to increase as Tⁿ in the positive TCR regime, the negative TCR range is typically characterized by an exp(Tⁿ) behavior. At the transition regime where nearly zero TCRs are obtained, it is believed that conduction is dominated by tunneling mechanisms.

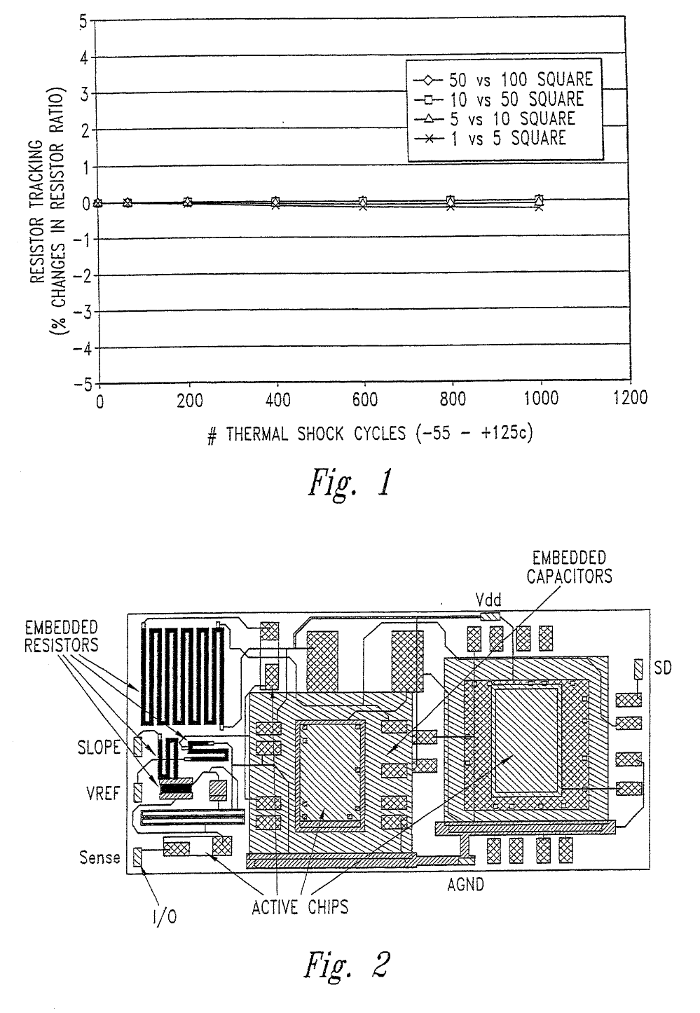

The material systems hereinafter described were cermets which used refractory metals with SiO₂ as the dielectric. The depositions were performed by either co-sputtering a cermet and a metal target or by single sputtering a composite ceramic/metal target. The W/SiOₓ material, the primary material investigated, was demonstrated to provide a sheet resistance nearly two orders of magnitude larger than conventional tantalum nitride thin film resistors. Although different existing systems may exhibit some of the desirable properties, the novelty of this system is that these resistors exhibit all of the desired properties simultaneously: no annealing required to obtain desired properties, easily dry etchable, high resistivity (˜0.2-1.5×10⁻² Ω-cm), low thermal coefficient of resistance (near zero) and high reliability in both long term high temperature stability (>1000 hrs@+125° C.) and thermal shock testing (1000 cycles, −55-+125° C.). The material and process development for these films was completed. Films in the range of 0.2-1.5×10⁻² Ω-cm were tested. These films were shown to have excellent reproducibility and reliability. FIG. 1 shows the results of 1000 cycles of thermal shock testing (−55-+125° C.) for a 0.25×10⁻² Ω-cm film. Tracking of neighboring resistors is of high importance to designers. These resistors have excellent tracking capability. The tracking was ≦0.2% for the pair with a 1 square resistor and ≦0.02% for all other resistor pairs.

The use of the herein disclosed resistor films was successfully demonstrated in an MCM-D current sense module for a VHD (very high density) power supply. The technology for integrating these resistors into conventional printed wiring boards has also been demonstrated.

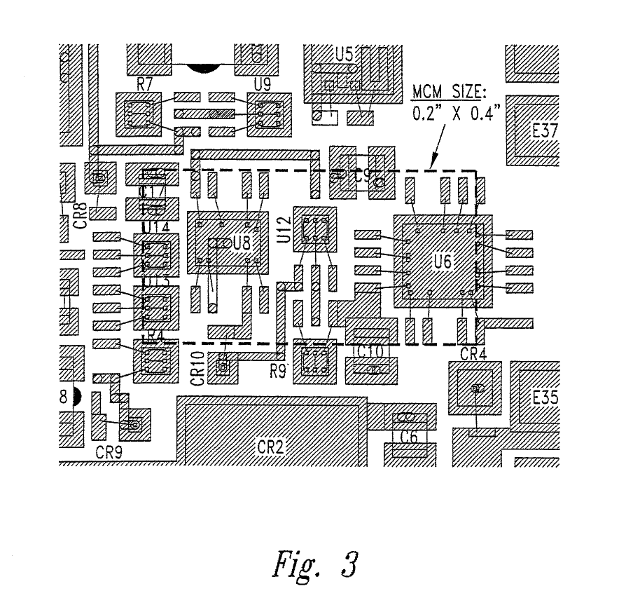

Prototypes of a current sense module have been fabricated using the herein described resistors as seen in FIG. 2. The final size of the current sense multichip module using embedded passives was 47% smaller than the original hybrid board area that it replaced. (See FIG. 3).

Preferred Process for Deposition of W/SiOₓ

The film is deposited on substrates using RF Magnetron sputtering Argon as the sputtering gas. The sputtering target is a single 8″ diameter by ¼″ thick, W/SiO₂ 85/15 wt % composite target. Prior to deposition of the resistor material, a titanium deposition is performed (using dummy wafers) in order to get oxygen/air from the chamber. This step may not be necessary depending on the quality of the vacuum system. The resistivity and the TCR can be controlled by varying the sputtering power and pressure. Examples of deposition conditions with corresponding Rs and TCR values are shown in the table below. These values were obtained by depositing an approximately 1000 Å thick resistor film on oxidized silicon substrates.

| Rs (ohms/Square | TCR (ppm/C) | Pressure (mTorr) | Power (kW) |
|---|---|---|---|
| 250 | ≦−200 | 10 | 2.0 |
| 400 | ≦−220 | 14 | 1.0 |
| 800 | ≦−260 | 14 | 0.4 |
| 1500 | ≦−400 | 18 | 0.4 |

After the resistor material is deposited on the oxidized silicon substrate, the material is then patterned using standard thin film photolithography and etch processing. The dry etch process can be carried out using a fluorine based plasma.

For use in high density interconnect substrates, conventional printed wiring boards or MCM-LS, Cu foil is first pre-cleaned (see detailed Cu foil pre-clean procedure below) then placed in the sputtering chamber. An ion clean is then performed, followed by deposition of the resistor material onto the Cu foil. The W/SiOₓ coated Cu foil can then be directly inserted into the typical printed wiring board (PWB) process (see detailed process flow for resistors on Cu/FR-4, below).

Cu Foil Pre-Clean

A strong effort to insure adequate pre-clean was the use of a 1 oz. Cu foil and a resistor layer 1 μm thick. It was necessary to insure that the material was thick enough to be continuous on the rougher than normal substrate surface (Si wafers being the normal surface).

Cu Pre-Cleaning Procedure:

1. Wet a sample copper foil and scrub it with a jitter-bug scotch bright until the surface is shiny and smooth.

2. Clean in tank for a minimum of 3 minutes.

3. Rinse thoroughly in distilled water for a minimum of 1 minute in several tanks.

4. Immerse in 15% sulfuric acid for a minimum of 3 minutes.

5. Rinse thoroughly in distilled water for a minimum of 1 minute in several tanks.

6. Dry the sample immediately with a paper towel and/or nitrogen gun to avoid oxidation.

All steps were performed at room temperature.

It is believed that both etch and rinse time is not critical unless it is no less than one minute; although, to the benefit of the process it may be increased.

Detailed Process Flow for Resistors on Copper

Pre-Clean Cu foil.

Bond Cu—W/SiOₓ samples to a fire retardant epoxy resin/class cloth laminate (FR-4) (with the W/SiOₓ side towards the FR-4 using Allied Signal noflow epoxy prepreg.

Drill two ½″ tooling holes in each sample for pattern registration.

Lightly scrub copper using a jitterbug with Scotchbrite pad, de-smut with gauze, rinse.

Dry in oven at 66° C. for 20 minutes.

Apply Dupont 4600 series dry resist.

Expose pattern.

Develop pattern.

Etch copper (wet).

Strip resist.

Etch tungsten (dry, clean room).

Lightly scrub copper using a jitterbug with Scotchbrite pad, de-smut with gauze, rinse.

Dry in oven at 66° C. for 20 minutes.

Apply Dupont 4600 series dry resist.

Expose 2nd pattern.

Develop pattern.

Etch copper (wet).

Strip resist.

X-Ray Analysis of W/SiOₓ

250 Ω/Square Material

Likely major components are W₃O and W₅Si₃. Multitude of peaks around 40 deg prevents distinct identification. Some W is present. Amorphous peak at 20 deg attributed to Si and/or Si—O phases.

400, 800 & 1500 Ω/Square Material

In general, the results seem reasonable in that the peaks correspond for the most part to Wsi and WO compounds, the 400 ohm material is the most crystalline, and the 1500 ohm material is the least crystalline with a significant, broad amorphous peak between 20-30 deg of 2 theta. Annealing of the 1500 ohm film for 2 hours at 400° C. did not change the xtallinity of the film, and is believed to be a good indication that the microstructure is fairly stable and subsequent processing during MCM fabrication should not significantly affect the resistors.

1. An embedded resistor comprising a thin film cermet material deposited by sputtering on a substrate and having a nearly zero TCR, said thin film cermet material comprising MₓSiy0_{z},
where M=W or Ta

2. The invention according to claim 1 wherein deposition onto the substrate is performed by sputtering of a composite target of W, or Ta, and SiO₂.

3. The invention according to claim 1 wherein deposition onto the substrate is performed by co-sputtering of two targets: a first target of W or Ta and a second target of SiO₂.

4. The invention according to claim 2 wherein said substrate is copper foil.

5. The invention according to claim 3 wherein said substrate is copper foil.

6. The invention according to claim 2 wherein said thin film cermet material is deposited by r.f. sputtering on a substrate.

7. The invention according to claim 3 wherein sputtering of said SiO₂ target is r.f. sputtering.

8. A method for forming a cermet thin film resistor such as the one described in claim 6 including the steps of:
depositing said thin film resistor on a substrate utilizing r.f. magnetron sputtering with argon gas; and,
controlling the resistivity and TCR of said cermet in film resistor by varying the sputtering power and pressure.

9. A method for forming a cermet thin film resistor such as the one described in claim 7, which includes the steps of: deposition of the film on a substrate utilizing r.f. and d.c. magnetron sputtering with argon gas; and controlling the resistivity and TCR of the cermet thin film by varying the sputtering power and pressure.

10. The method according to claim 8 wherein the resistor film is approximately 1000 angstroms thick and the substrate comprises an oxidized silicon substrate; the method including the further steps of controlling sputtering power and pressure to obtain Rs and TCR values in accordance with the following table:

| Rs (ohms/Square | TCR (ppm/C) | Pressure (mTorr) | Power (kW) |
|---|---|---|---|
| 250 | ≦−200 | 10 | 2.0 |
| 400 | ≦−220 | 14 | 1.0 |
| 800 | ≦−260 | 14 | 0.4 |
| 1500 | ≦−400 | 18 | 0.4 |
